(19) United States
(12) Patent Application Publication
(10) Pub. No.: US 2023/0306354 A1
(43) Pub. Date: Sep. 28, 2023

(54) INFORMATION PROCESSING APPARATUS, NON-TRANSITORY COMPUTER READABLE MEDIUM STORING COMPUTER PROGRAM, AND INFORMATION PROCESSING METHOD

(71) Applicant: FUJIFILM Business Innovation Corp., Tokyo (JP)

(72) Inventor: Satoshi KONDO, Kanagawa (JP)

(73) Assignee: FUJIFILM Business Innovation Corp., Tokyo (JP)

(21) Appl. No.: 17/864,373

(22) Filed: Jul. 13, 2022

(30) Foreign Application Priority Data
Mar. 28, 2022 (JP) 2022-052353

(51) Int. Cl. G06Q 10/06; G06F 3/0482

(52) U.S. Cl. CPC G06Q 10/067; G06F 3/0482

(57) ABSTRACT

An information processing apparatus includes a processor configured to acquire work logs that are work logs in which an operation of data selected by a user and a work other than the operation of the data performed between a start of creation of the data and the creation of the data are recorded, and include a feature of the data, and present the acquired work logs for each user involved in the creation of the data.

### CROSS-REFERENCE TO RELATED APPLICATIONS

This application is based on and claims priority under 35 USC 119 from Japanese Patent Application No. 2022-052353 filed Mar. 28, 2022.

### BACKGROUND

### (i) Technical Field

The present invention relates to an information processing apparatus, a non-transitory computer readable medium storing a computer program, and an information processing method.

### (ii) Related Art

JP2018-81414A discloses an information processing apparatus including a reception section that receives an instruction related to processing of a document, and an extraction section that extracts information which is related to the document or the instruction and is used for generating a workflow including the processing of the document.

JP2015-32203A discloses a knowledge system creation apparatus including a first storage unit, a second storage unit, a first extraction unit, a second extraction unit, and a systematization unit. The first extraction unit extracts information related to business operation including at least one of a work name or a category name stored in the first storage unit from an access history to a file related to each business operation and information related to business operation stored in the second storage unit. The second extraction unit extracts words by acquiring information related to business operation including the category name in the extracted information related to business operation. The systematization unit specifies a word of which a feature amount indicating a relationship with the category name exceeds a first threshold value among the words, and generates a knowledge system in which the specified word is arranged in a lower layer of the category name arranged uppermost in a hierarchical structure, and the information related to business operation acquired by the second extraction unit is arranged in a lower layer of the specified word.

JP2010-157183A discloses an information processing apparatus including an operation history reception section that receives an operation history of a document, a business operation procedure extraction section that extracts a procedure of business operation based on the operation history received by the operation history reception section, and a presentation section that presents the procedure of business operation extracted by the business operation procedure extraction section.

### SUMMARY

A plurality of works are present in a series of business operation process from a start of a business operation to creation of data that is a target of the business operation, and some works involve a plurality of users. Thus, visualizing a final business operation process by identifying every content of the works requires a large effort.

Aspects of non-limiting embodiments of the present disclosure relate to an information processing apparatus, a non-transitory computer readable medium storing a computer program, and an information processing method that visualize a series of business operation processes from a start of a business operation to creation of data which is a target of the business operation independently of human effort.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire work logs that are work logs in which an operation of data selected by a user and a work other than the operation of the data performed between a start of creation of the data and the creation of the data are recorded, and include a feature of the data, and present the acquired work logs for each user involved in the creation of the data.

### BRIEF DESCRIPTION OF THE DRAWINGS

Exemplary embodiment(s) of the present invention will be described in detail based on the following figures, wherein:

FIG. 1 is a diagram illustrating a schematic configuration of an information processing system including an information processing apparatus according to an exemplary embodiment of the disclosed technology;

FIG. 2 is a block diagram illustrating a hardware configuration of the information processing apparatus;

FIG. 3 is a block diagram illustrating an example of functional configurations of the information processing apparatus;

FIG. 4 is a diagram illustrating an example of a user interface;

FIG. 5 is a diagram illustrating an example of the user interface;

FIG. 6 is a diagram illustrating an example of the user interface;

FIG. 7 is a diagram illustrating an example of the user interface;

FIG. 8 is a diagram illustrating an example of the user interface;

FIG. 9 is a diagram illustrating an example of the user interface;

FIG. 10 is a diagram illustrating an example of the user interface;

FIG. 11 is a diagram illustrating an example of the user interface;

FIG. 12 is a diagram illustrating an example of the user interface;

FIG. 13 is a diagram illustrating an example of the user interface;

FIG. 14 is a diagram illustrating an example of the user interface;

FIG. 15 is a diagram illustrating an example of the user interface;

FIGS. 16A and 16B are diagrams illustrating an example of the user interface;

FIG. 17 is a diagram illustrating an example of the user interface;

FIG. 18 is a diagram illustrating an example of the user interface; and

FIG. 19 is a flowchart illustrating a flow of information processing performed by the information processing apparatus.

### DETAILED DESCRIPTION

Hereinafter, an example of an exemplary embodiment of the present disclosure will be described with reference to the drawings. In each drawing, identical or equivalent constituents and parts are designated by identical reference signs. In addition, dimensional ratios in the drawings are exaggerated for convenience of description and may be different from actual ratios.

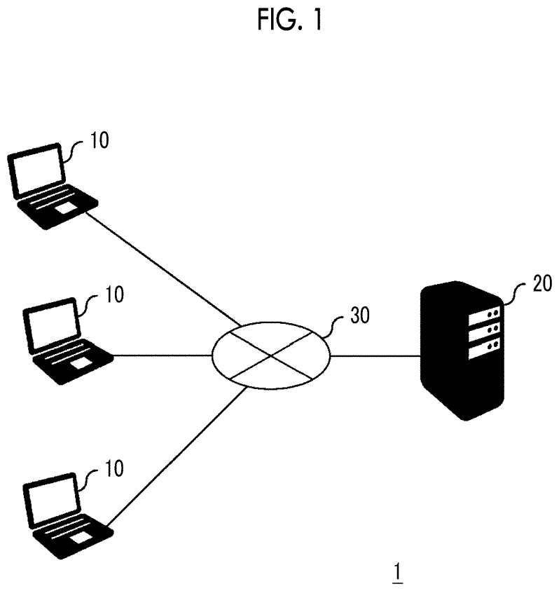

FIG. 1 is a diagram illustrating a schematic configuration of an information processing system 1 including an information processing apparatus according to the present exemplary embodiment.

The information processing system 1 illustrated in FIG. 1 is configured to include a plurality of information processing apparatuses 10 and a server 20. Each information processing apparatus 10 and the server 20 are connected through a network 30 such as the Internet or an intranet.

The information processing apparatus 10 is an apparatus used by a user and is, for example, a desktop or laptop personal computer. The user executes a work such as creation of an email or a message, an online conference, creation of data, or delivery of data using the information processing apparatus 10. In addition, the user causes the information processing apparatus 10 to visualize a series of business operation processes from a start of a business operation to creation of data that is a target of the business operation based on work logs stored in the server 20 using the information processing apparatus 10.

In a case where the data created by the user is designated, the information processing apparatus 10 acquires work logs that are work logs in which operation of the data and a work other than the operation of the data are recorded and includes a feature of the data, from the server 20. The feature of the data may be at least any of a user involved in the creation of the data, a file name of the data, a title of the data, or a sentence described in the data. The information processing apparatus 10 presents the work logs acquired from the server 20 for each user involved in the creation of the data. The work logs of a target to be acquired by the information processing apparatus 10 are work logs from a start of the creation of the data to the creation of the data. A point in time when the creation of the data is started is not limited to a point in time when the creation of the data is actually started by the user. For example, a point in time when the information processing apparatus 10 of the user receives an email or a message of a request to create the data may be the point in time when the creation of the data is started. In addition, for example, a point in time when an email or a message for assigning a creator of the data is transmitted may be the point in time when the creation of the data is started.

The server 20 stores work logs for a work performed by the user using the information processing apparatus 10. The work logs stored in the server 20 include transmission and reception of an email or a message, creation of data, an online conference, access logs to a database, and the like.

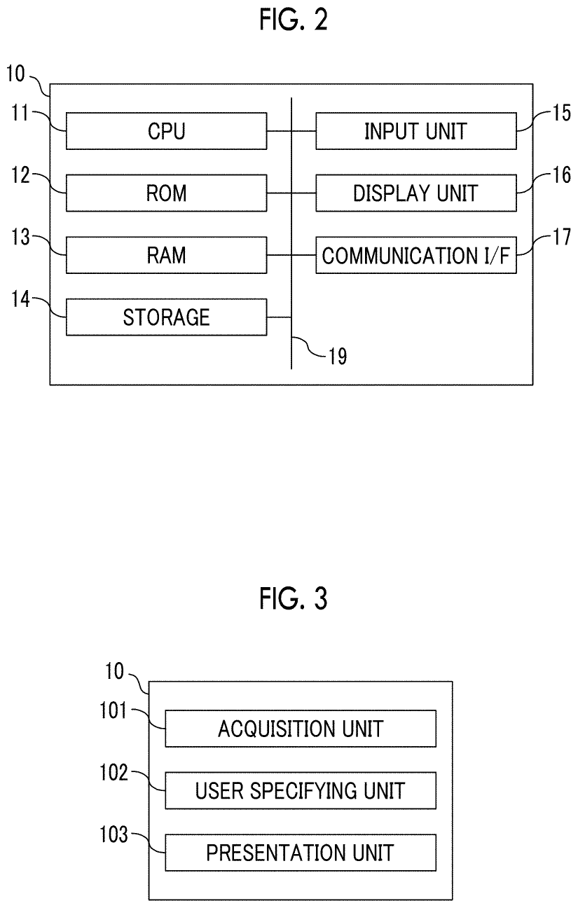

FIG. 2 is a block diagram illustrating a hardware configuration of the information processing apparatus 10.

As illustrated in FIG. 2, the information processing apparatus 10 includes a central processing unit (CPU) 11, a read only memory (ROM) 12, a random access memory (RAM) 13, a storage 14, an input unit 15, a display unit 16, and a communication interface (I/F) 17. These configurations are communicably connected to each other via a bus 19.

The CPU 11 is a central calculation processing unit and executes various programs or controls each unit. That is, the CPU 11 reads a program from the ROM 12 or the storage 14 and executes the program using the RAM 13 as a work region. The CPU 11 controls each configuration and performs various calculation processes in accordance with the program recorded in the ROM 12 or the storage 14. In the present exemplary embodiment, the ROM 12 or the storage 14 stores an information processing program for visualizing the business operation processes.

The ROM 12 stores various programs and various data. The RAM 13 temporarily stores a program or data as the work region. The storage 14 is configured with a storage apparatus such as a hard disk drive (HDD), a solid state drive (SSD), or a flash memory and stores various programs including an operating system and various data.

The input unit 15 includes a pointing device such as a mouse and a keyboard, and is used for providing various inputs.

The display unit 16 is, for example, a liquid crystal display and displays various information. The display unit 16 may function as the input unit 15 by employing a touch panel type.

The communication interface 17 is an interface for communicating with another apparatus such as another information processing apparatus 10 or the server 20 and uses standards such as Ethernet (registered trademark), FDDI, and Wi-Fi (registered trademark).

In a case of executing an information processing program described above, the information processing apparatus 10 implements various functions using hardware resources described above. Functional configurations implemented by the information processing apparatus 10 will be described.

FIG. 3 is a block diagram illustrating an example of functional configurations of the information processing apparatus 10.

As illustrated in FIG. 3, the information processing apparatus 10 includes an acquisition unit 101, a user specifying unit 102, and a presentation unit 103 as the functional configurations. Each functional configuration is implemented by causing the CPU 11 to read and execute the information processing program stored in the ROM 12 or the storage 14.

The acquisition unit 101 acquires the work logs from the server 20 in the presentation of the work logs. The work logs acquired by the acquisition unit 101 are work logs that are work logs in which the operation of the data designated by the user and a work other than the operation of the data are recorded, and include the feature of the data. Not only one user but also a plurality of users may involve in creation of one piece of data. Therefore, work logs of a user specified by the user specifying unit 102, described later, are also an acquisition target of the acquisition unit 101.

The designation of the data by the user may be performed via a user interface presented by the presentation unit 103, described later. An example of the user interface presented by the presentation unit 103 will be described later.

The acquisition unit 101 decides an acquisition range of the work logs of the acquisition target by analyzing the feature of the data designated by the user. The feature of the data includes information such as a file name, a title, a body, a creator of a file, and an editor of a file. The acquisition unit 101 may divide the file name, the body, the title, and the like into character strings by morphological analysis in order to output a feature word. In addition, the acquisition unit 101 may separately have a dictionary and use a word similar to the dictionary as the feature.

For example, in a case where certain document data is designated, the acquisition unit 101 performs the morphological analysis by extracting a keyword in the document data and uses the morphological analysis for deciding the acquisition range of the work logs. Examples of the keyword in the document data include proper nouns such as a person name, a company name, and a service name. In addition, in a case of an email, the acquisition unit 101 sets the acquisition range of the work logs to until an email having a title to which a text (for example, “Re:”) indicating a reply is not attached is specified, or until an email ahead of an original email ID is specified. In addition, the acquisition unit 101 sets the acquisition range of the work logs to a date and time described in properties of the file of the document data.

The user specifying unit 102 specifies a user involved in the creation of the data designated by the user. For example, the user specifying unit 102 specifies the user based on the feature of the data and the work logs acquired by the acquisition unit 101.

For example, the user specifying unit 102 specifies involvement of not only a certain user (referred to as a user A) but also a different user (referred to as a user B) in creation of certain data from the work logs acquired by the acquisition unit 101. Specifically, for example, the user specifying unit 102 specifies the user involved in the creation of the data from a work other than the creation of the data, such as a content of the email or the message or a participant of a Web conference. A specific example of specifying the user will be described in detail later.

In a case where the user specifying unit 102 specifies the user, the acquisition unit 101 acquires the work logs by expanding the range to the user newly specified by the user specifying unit 102. In the above example, in a case where the involvement of not only the user A but also the user B in the creation of the data is recognized, the acquisition unit 101 also acquires work logs of the user B.

The presentation unit 103 presents information related to the acquisition of the work logs and the acquired work logs. For example, the presentation unit 103 presents a user interface for receiving an instruction to acquire and present the work logs on the display unit 16. In addition, for example, the presentation unit 103 presents a user interface for displaying the work logs acquired by the acquisition unit 101 for each user on the display unit 16. In the presentation of the work logs, the presentation unit 103 may simply present the work logs in a list form or present the work logs in the form of a business operation flow for the creation of the data. Examples of the user interfaces presented by the presentation unit 103 will be described in detail later.

In a case where the work logs acquires by the acquisition unit 101 are presented in the form of the business operation flow, the presentation unit 103 may present a user interface for the user to edit each business operation of the presented business operation flow. In the present exemplary embodiment, in each business operation of the business operation flow, a task is defined as a series of work units of a work of an individual or a plurality of persons having a designated period, and a phase is defined as a segment of one or more tasks based on an increase or a decrease in the number of persons involved in the business operation or an interval with a previous task. The presentation unit 103 may present a user interface for the user to edit a task or a phase of the business operation flow.

Next, a presentation process of the work logs by the information processing apparatus 10 will be described in further detail.

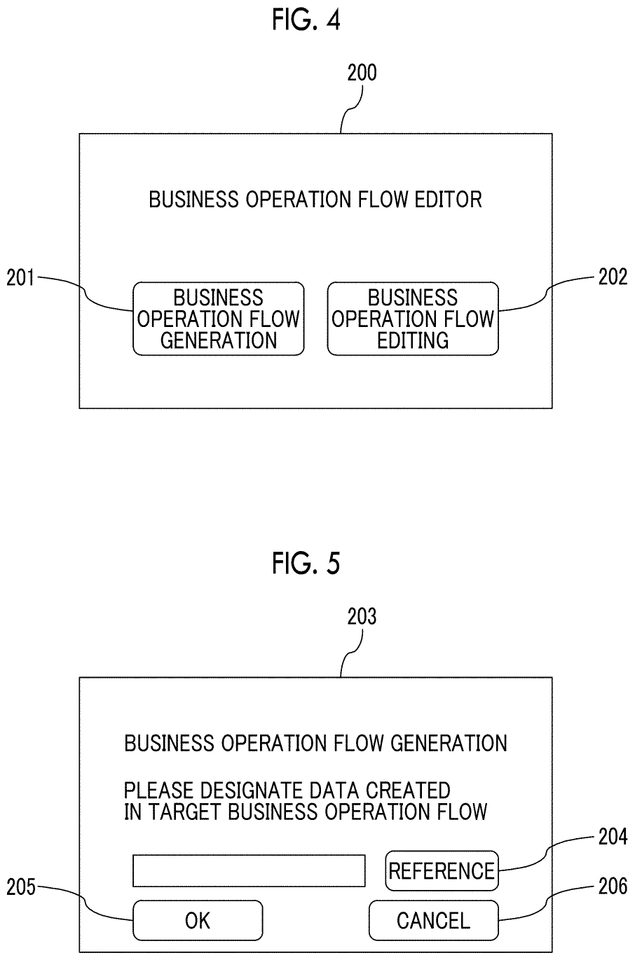

FIG. 4 is a diagram illustrating an example of the user interface presented on the display unit 16 by the information processing apparatus 10 according to the present exemplary embodiment. A state where a business operation flow editor for creating and editing the business operation flow can be executed is set in advance in the information processing apparatus 10. A user interface 200 illustrated in FIG. 4 is an example of a main menu screen of the business operation flow editor. A button 201 for generating the business operation flow by the information processing apparatus 10 and a button 202 for the user to edit the business operation flow are displayed on the main menu screen of the business operation flow editor. An editing target of the business operation flow may include both of a business operation flow automatically generated by the information processing apparatus 10 and a business operation flow created by the user.

In the following description, a user who generates the business operation flow and edits the business operation flow may be referred to as a “business operation analyst”, and a user who executes the business operation may be referred to as a “business operation responsible person” for distinction.

FIG. 5 is a diagram illustrating an example of the user interface presented on the display unit 16 by the information processing apparatus 10 according to the present exemplary embodiment. FIG. 5 illustrates an example of the user interface presented on the display unit 16 by the information processing apparatus 10 after the button 201 in FIG. 4 is selected by the business operation analyst. A user interface 203 for selecting data created by a certain business operation responsible person is illustrated in FIG. 5. A button 204 for selecting the data by referring to a location of the data, a button 205 for executing the generation of the business operation flow, and a button 206 for returning to a previous screen (user interface 200) are displayed in the user interface 203.

In a case where the business operation analyst selects the button 205 after selecting the data to be a target by selecting the button 204, the information processing apparatus 10 executes a process of extracting work logs related to the selected data from the server 20 and presenting the work logs for each business operation responsible person involved in the creation of the data. Hereinafter, an example of the presentation process of the work logs by the information processing apparatus 10 will be described.

In a case where data is specified by the business operation analyst, the information processing apparatus 10 first specifies the business operation responsible person who has created the data by the user specifying unit 102. Here, the information processing apparatus 10 is assumed to specify the user A as the business operation responsible person who has created the data. The information processing apparatus 10 performs a process of specifying whether or not other users involved in the creation of the data are present by acquiring the work logs of the user A by the acquisition unit 101 and finding the other users through the work logs of the user A.

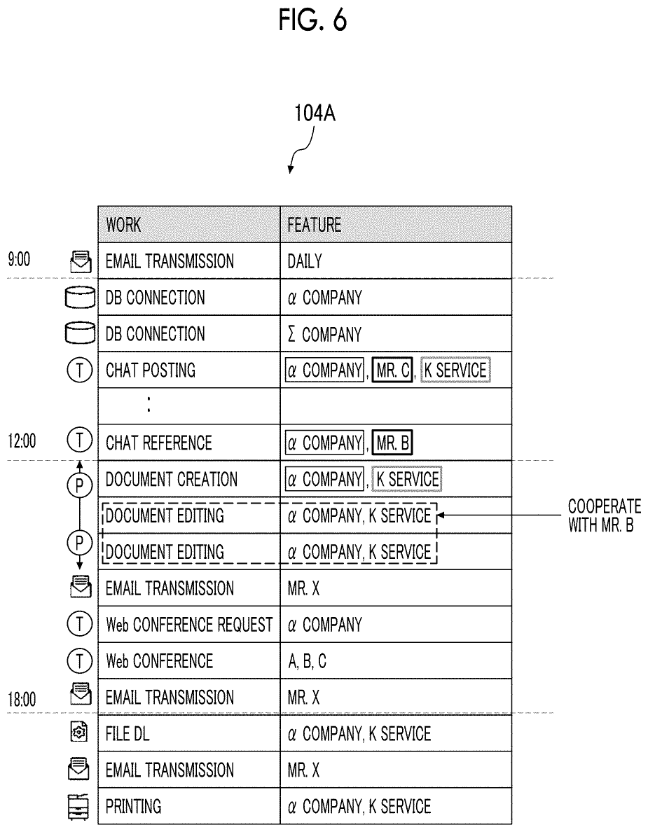

FIG. 6 is a diagram illustrating an example of work logs 104A of the user A on a certain day. The information processing apparatus 10 is assumed to realize that the data designated by the business operation analyst is a material for proposing “K service” for “α company” by analyzing the acquired data by the acquisition unit 101. The user specifying unit 102 specifies a work related to “α company” or “K service” from the work logs of the user A and also specifies users related to the work. In the example in FIG. 6, the user specifying unit 102 can specify “Mr. B” (hereinafter, referred to as the user B) and “Mr. C” (hereinafter, referred to as a user C) as the users related to the work related to “α company” or “K service” in chat posting performed in the morning. Similarly, the example of the work logs in FIG. 6 illustrates that a document editing work for “α company” performed in the afternoon is a cooperative work between the user A and the user B. In addition, similarly, the example of the work logs in FIG. 6 illustrates that the users A, B, and C participate in a Web conference related to “α company” held in the afternoon. Even from this information, the user specifying unit 102 can specify the user B and the user C as the users related to the work related to “α company” and “K service”.

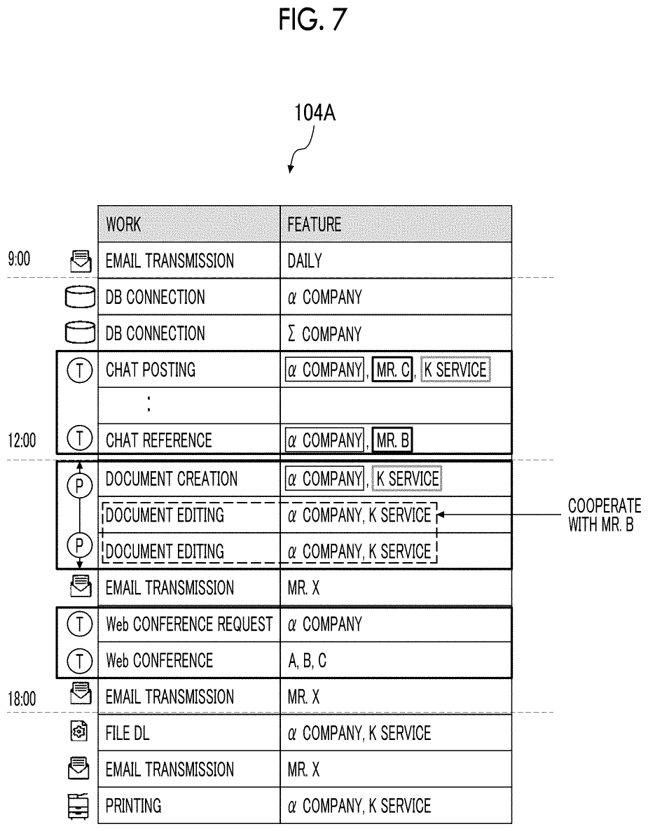

FIG. 7 is a diagram illustrating an example of the work logs 104A of the user A on a certain day and is a diagram illustrating a work related to “α company” or “K service” and other users in a highlighted manner. In FIG. 7, chat posting, document creation and editing, and a Web conference are illustrated in a highlighted manner.

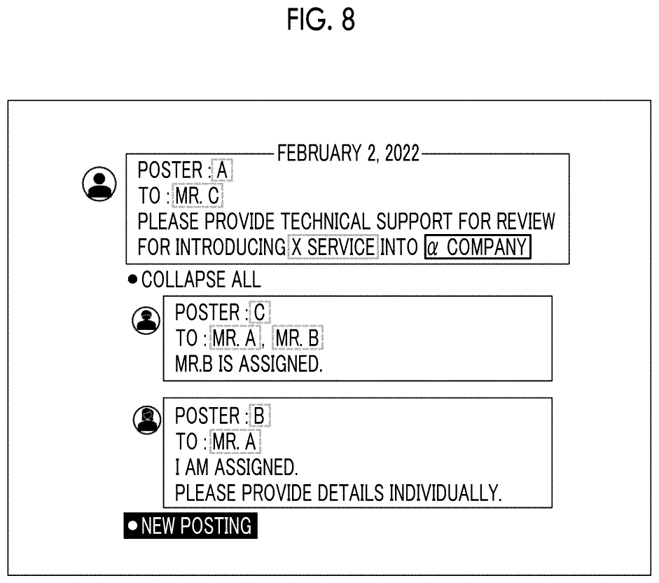

FIG. 8 is a diagram illustrating a specific example of the chat posting illustrated in FIG. 7. In the example illustrated in FIG. 8, posting in which the user A requests technical support from the user C for a review for introducing K service into α company is performed. In addition, in the example illustrated in FIG. 8, posting in which the user C assigns the user B by receiving the posting of the user A is performed, and posting in which the assigned user B requests detailed presentation from the user A is performed.

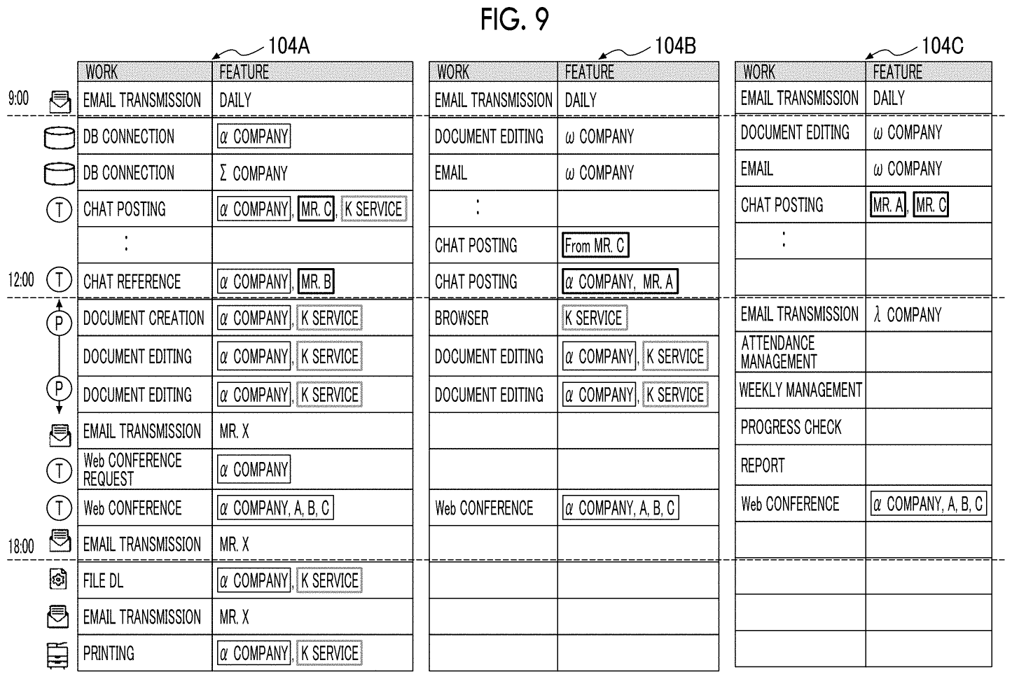

FIG. 9 is a diagram illustrating an example of the work logs 104A of the user A, work logs 104B of the user B, and work logs 104C of the user C on a certain day. In the work logs 104B of the user B and the work logs 104C of the user C, two persons of the user B and the user C are perceived as performing the work related to “α company” or “K service”.

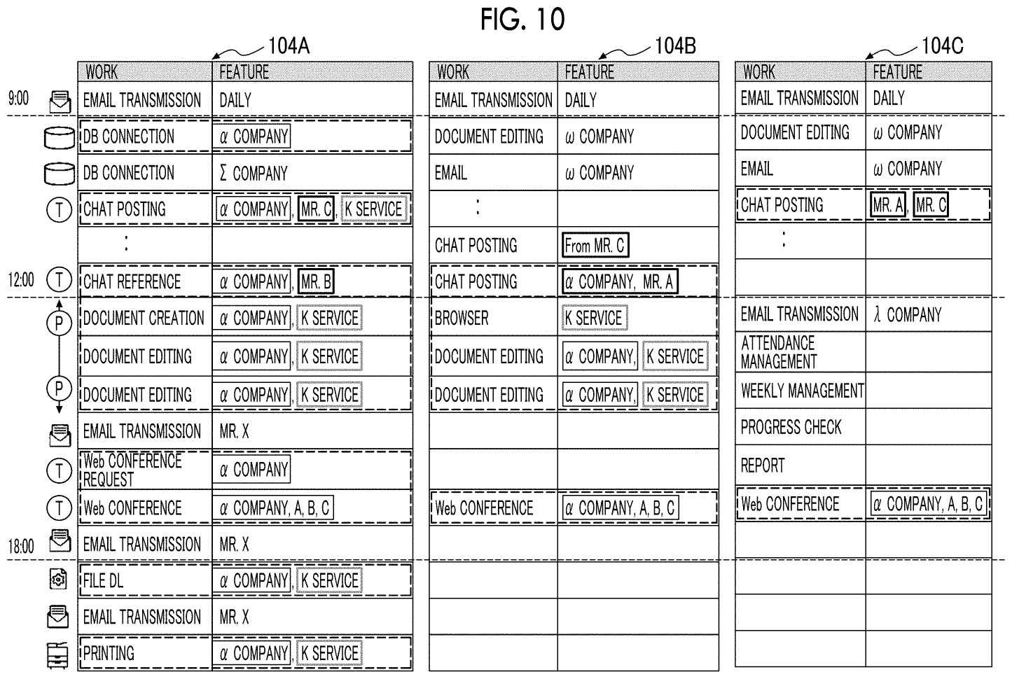

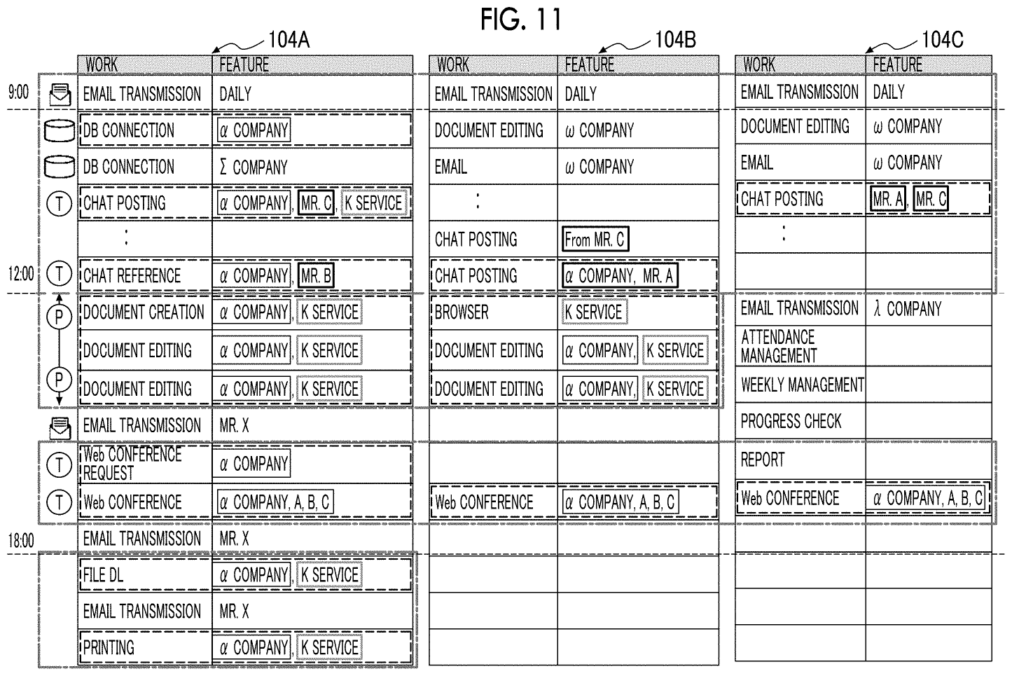

In a case where the work logs of the user involved in the creation of the data are acquired, next, the information processing apparatus 10 specifies a task and a phase from contents of the work logs by the presentation unit 103 in order to easily present a series of works as a business operation flow by the presentation unit 103. FIG. 10 is a diagram illustrating an example of the work logs 104A of the user A, the work logs 104B of the user B, and the work logs 104C of the user C on a certain day and is a diagram illustrating a state where the presentation unit 103 specifies a task from the work logs of each user. A work surrounded by a broken line in FIG. 10 is a work specified as a task. The work specified as a task may be a single work or consecutive works. In the example illustrated in FIG. 10, the presentation unit 103 specifies a series of works of document creation and document editing of the user A as one task.

FIG. 11 is a diagram illustrating an example of the work logs 104A of the user A, the work logs 104B of the user B, and the work logs 104C of the user C on a certain day and is a diagram illustrating a state where the presentation unit 103 specifies a phase from the work logs of each user. A work surrounded by a dot-dashed line in FIG. 10 is a work specified as a phase. For example, in a case where a time interval between tasks in the work logs is greater than or equal to a predetermined threshold value, the presentation unit 103 presents the former task and the latter task separately in different phases. In addition, for example, the presentation unit 103 presents a common task between users as one phase and sets a point in time when the common task is finished as a boundary of the phase. In addition, for example, the presentation unit 103 presents a point in time when a tool (application) used by the user changes as a boundary of the phase.

Next, presentation examples of information by the information processing apparatus 10 will be described.

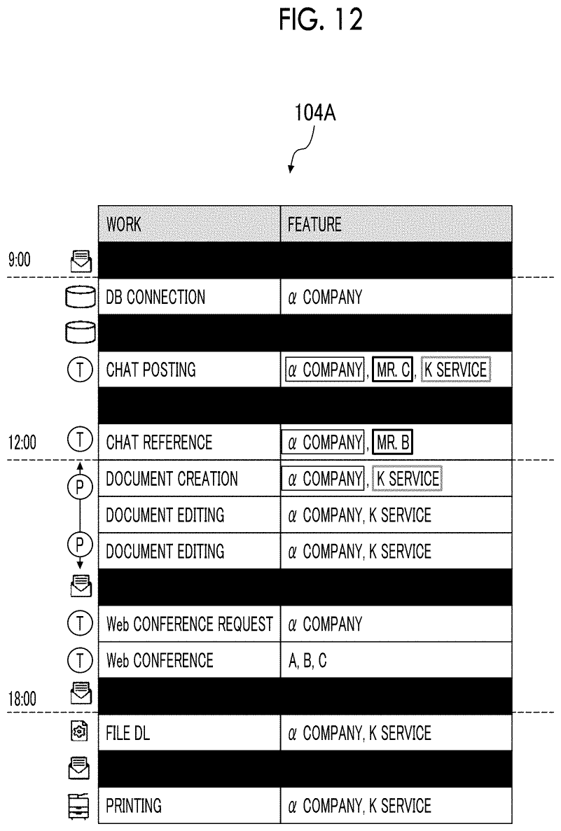

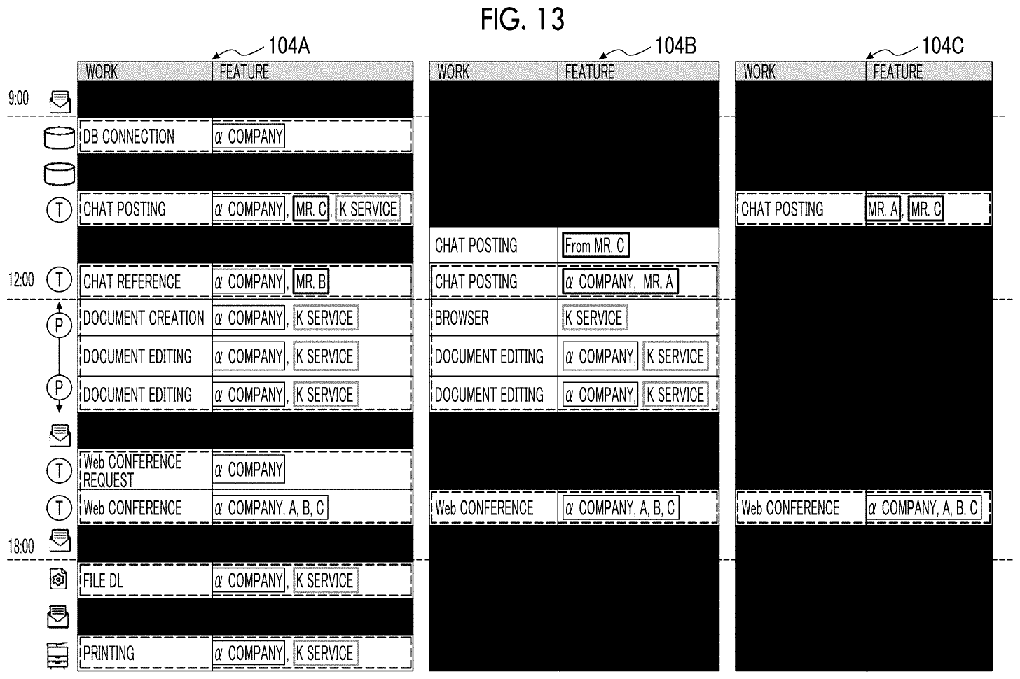

The presentation unit 103 may present the work logs acquired from the server 20 by masking a business operation not related to the creation of the data. FIG. 12 is a diagram illustrating an example of information presented by the information processing apparatus 10. The information processing apparatus 10 may present the work logs 104A of the user A acquired from the server 20 by masking a business operation not related to the creation of the data.

The presentation unit 103 may present work logs of a plurality of users in a row. Even in this case, the presentation unit 103 may present the work logs by masking a business operation not related to the creation of the data. FIG. 13 is a diagram illustrating an example of the information presented by the information processing apparatus 10. The information processing apparatus 10 may present the work logs 104A of the user A, the work logs 104B of the user B, and the work logs 104C of the user C acquired from the server 20 by masking a business operation not related to the creation of the data.

In the presentation of the work logs acquired from the server 20 in the form of a business operation flow, the information processing apparatus 10 may present the work logs by representing a content of each business operation in an image form corresponding to the work. For example, the image may be an icon of an application or a service used in the work.

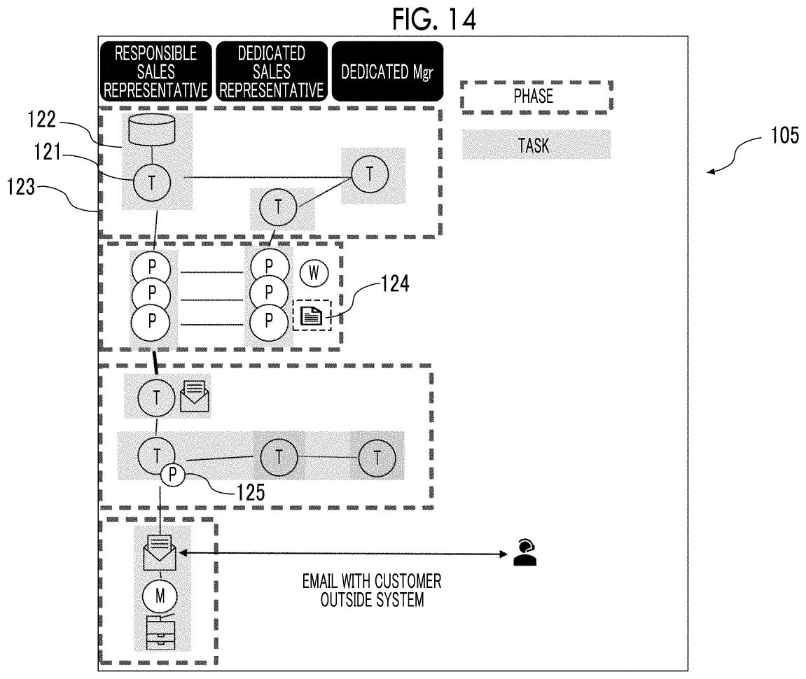

FIG. 14 is a diagram illustrating an example of the information presented by the information processing apparatus 10. In FIG. 14, an example of a business operation flow 105 presented by the presentation unit 103 based on the work logs acquired from the server 20 is illustrated. In the business operation flow 105, an upper part in FIG. 14 is old in time, and a lower part is new in time. In FIG. 14, an example of the business operation flow 105 of a responsible sales representative (user A), a dedicated sales representative (user B), and a dedicated manager (user C) is illustrated. The business operation flow 105 is generated based on the work logs illustrated in FIG. 13. In the business operation flow 105, the content of the business operation is illustrated by an icon 121 that is an example of the image. In addition, in the business operation flow 105, a task and a phase are denoted by reference numeral 122 and reference numeral 123, respectively, in an identifiable aspect. In the example in FIG. 14, while the task is illustrated by a solid line frame, and the phase is illustrated by a broken line frame, an aspect of presentation of the task and the phase is not limited to such an example in the present invention.

In the presentation of the business operation flow, the presentation unit 103 may present a length of a time between tasks in an identifiable aspect. For example, the presentation unit 103 may present the length of the time between tasks by a difference in color or a difference in thickness of a line.

In the presentation of the business operation flow, the presentation unit 103 may present a common work between users and a work not common between users in different display aspects. For example, in the presentation of the business operation flow, the presentation unit 103 may present the common work between users by connecting the common work with a line. In the example in FIG. 14, the responsible sales representative and the dedicated sales representative cooperate in the creation of the data. Thus, the presentation unit 103 presents a common work for a task of creating the data by connecting the common work with a line.

In the middle of the business operation flow, data of an unknown source may be created for a reason such as automatic generation in the service. In the business operation flow illustrated in FIG. 14, an icon denoted by reference numeral 124 illustrates data of an unknown source. Since any work being performed is expected, the presentation unit 103 may display the data of the unknown source in a highlighted manner and prompt addition of the data as a task.

In addition, the presentation unit 103 may present the business operation flow to prompt the user to use a file edited at an end of a phase as a trace. In the business operation flow illustrated in FIG. 14, an icon denoted by reference numeral 125 illustrates a file edited at the end of the phase.

Detailed contents of the task and the phase of the business operation flow presented by the presentation unit 103 enable editing by the business operation analyst.

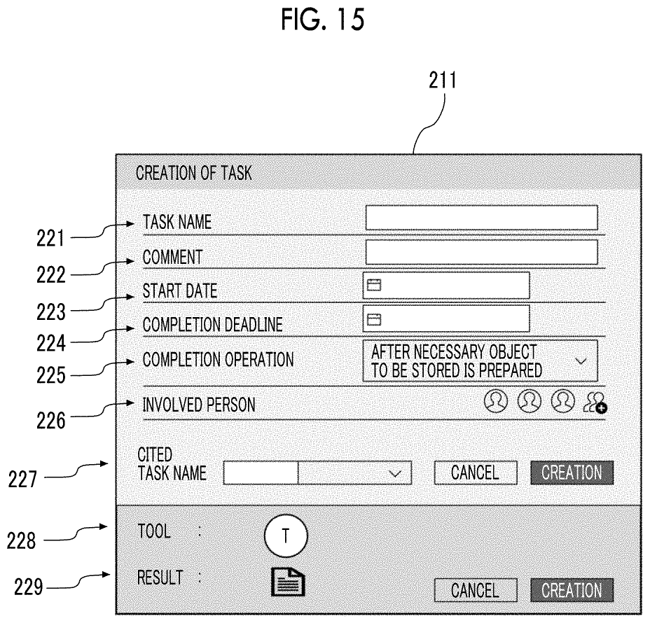

FIG. 15 is a diagram illustrating an example of the information presented by the information processing apparatus 10. In FIG. 15, a user interface 211 for editing the content of the task of the business operation flow is illustrated. An area 221 in which a name of the task is input, an area 222 in which a comment of the task is input, an area 223 in which a start date of the task is input, an area 224 in which a completion deadline of the task is input, an area 225 in which a completion operation of the task is selected, an area 226 in which a person involved in the task is set, an area 227 in which a cited task is set, an area 228 in which a tool used in the task is set, and an area 229 in which a result of the task is set are displayed in the user interface 211.

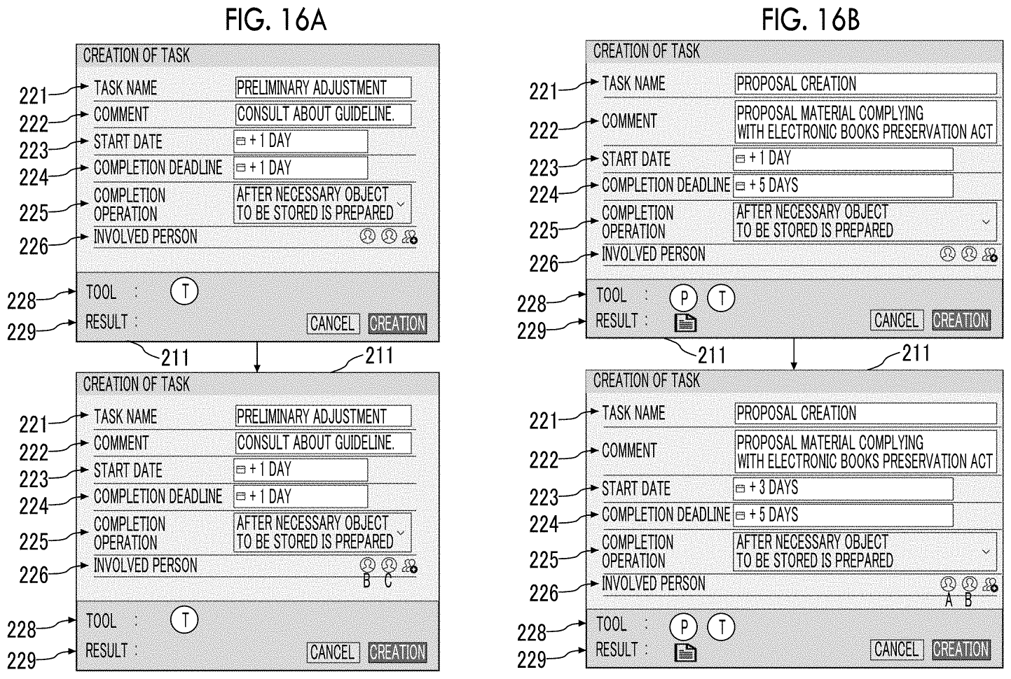

A user interface in a case where the business operation analyst edits the task of the business operation flow presented by the presentation unit 103 will be described. FIGS. 16A and 16B are diagrams illustrating an example of the information presented by the information processing apparatus 10. In FIGS. 16A and 16B, the user interface 211 for editing the content of the task of the business operation flow is illustrated. FIG. 16A illustrates a task of preliminary adjustment, and FIG. 16B illustrates a task of proposal creation. Numerical values are automatically input in the area 223 in which the start date of the task is input, and the area 224 in which the completion deadline of the task is input, from the business operation flow. In addition, a user actually involved in the task is displayed in the area 226 in which the person involved in the task is set.

In a case where the business operation analyst edits the task, the edited task is stored as a template. Lower parts of FIGS. 16A and 16B are an example of the task after being stored as a template. In a case where the task is stored as a template, the person involved in the task is converted to an anonymous user. The business operation responsible person can execute the task by referring to the task stored as a template and selecting the tool. For example, in FIG. 16A, the user involved in the task can be contacted by selecting the tool. In addition, in FIG. 16B, a material can be created together with the user involved in the task by selecting the tool.

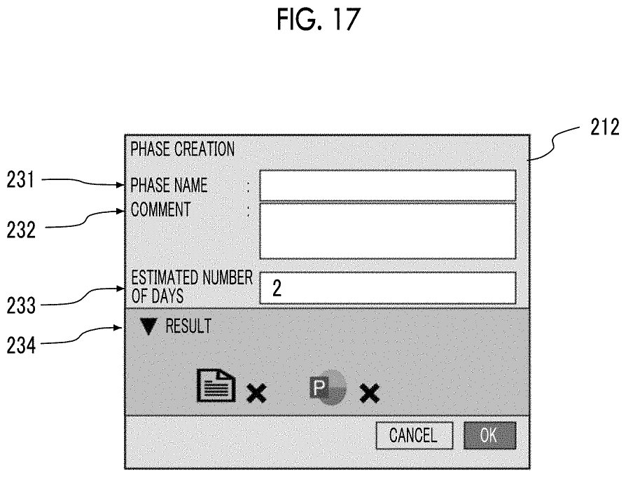

FIG. 17 is a diagram illustrating an example of the information presented by the information processing apparatus 10. In FIG. 17, a user interface 212 for editing the content of the phase of the business operation flow is illustrated. An area 231 in which a name of the phase is input, an area 232 in which a comment of the phase is input, an area 233 in which an estimated number of days of the phase is input, and an area 234 in which a result of the phase is set are displayed in the user interface 212.

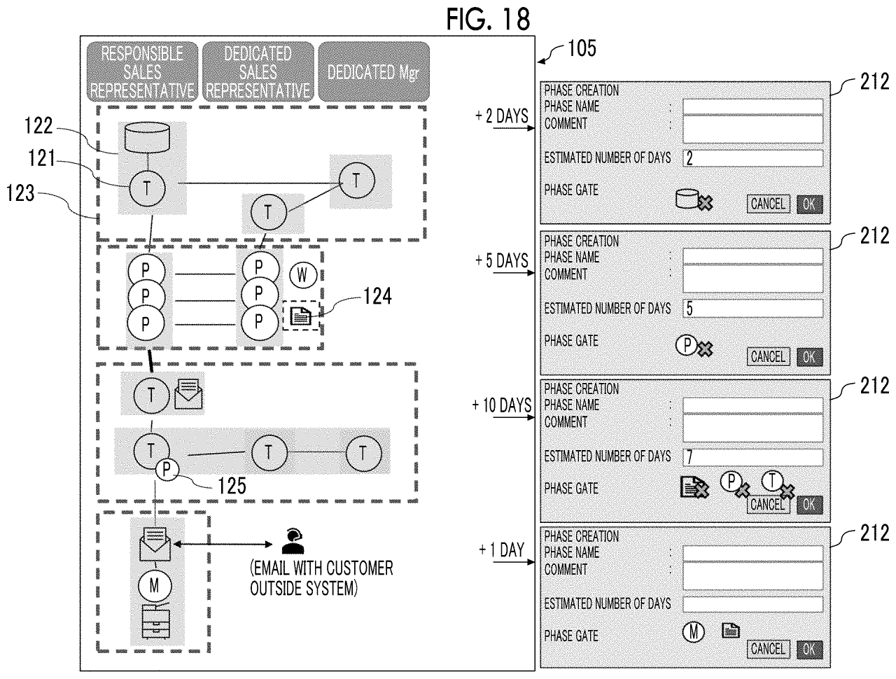

FIG. 18 is a diagram for describing an editing process of the phase by the business operation analyst. The presentation unit 103 may display the user interface 212 for editing the content of the phase in an overlapping manner with the business operation flow or may transition to a different screen to display the user interface 212. The presentation unit 103 displays a total processing time of each task in the phase in the area 233. In addition, the presentation unit 103 may cause the business operation analyst to input an estimated time in a phase creation panel. In a case where the estimated time is input by the business operation analyst, the presentation unit 103 may calculate a ratio of the estimated time from an actual work time of the task and perform presentation by changing the number of days for completing the tasks in the phase in accordance with the ratio of the work time of each task in the phase. For example, the presentation unit 103 is assumed to present an estimated number of days of a certain phase as 10 days, and then, the business operation analyst is assumed to change the number of days to 7 days. In this case, the presentation unit 103 performs presentation by changing the number of days for completing each task in the phase to 7/10.

In a case where the business operation analyst determines that data of the result presented in the area 234 by the presentation unit 103 is not necessary, the business operation analyst may delete the data displayed in the area 234.

The information processing apparatus 10 may cause the business operation analyst to create the business operation flow complying with the actual content of the business operation by presenting the business operation flow and causing the business operation analyst to edit the contents of the task and the phase of the business operation flow.

Next, an action of the information processing apparatus 10 will be described.

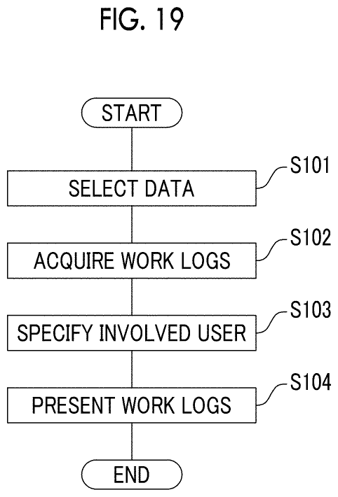

FIG. 19 is a flowchart illustrating a flow of information processing performed by the information processing apparatus 10. The information processing is performed by causing the CPU 11 to read the information processing program from the ROM 12 or the storage 14, load the information processing program into the RAM 13, and execute the information processing program.

In step S101, in a case where data is selected by the business operation analyst, the CPU 11 acquires work logs of a user who has created the selected data from the server 20 in step S102.

In a case where the work logs are acquired from the server 20, next, the CPU 11 specifies a user involved in the creation of the data by referring to the acquired work logs in step S103. In a case where other users involved in the creation of the data are present, the CPU 11 acquires work logs of the users from the server 20.

Next, the CPU 11 presents the work logs acquired from the server 20 in step S104. For example, the CPU 11 presents the user interface for displaying the work logs acquired from the server 20 for each user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

While an aspect in which the program for the information processing is prestored (installed) in the ROM or the storage is described in the exemplary embodiment, the present invention is not limited to the aspect. The program may be provided in the form of a recording on a non-temporary (non-transitory) recording medium such as a compact disk read only memory (CD-ROM), a digital versatile disk read only memory (DVD-ROM), and a universal serial bus (USB) memory. In addition, the program may be in the form of a download from an outside apparatus through a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire work logs that are work logs in which an operation of data selected by a user and a work other than the operation of the data performed between a start of creation of the data and the creation of the data are recorded, and include a feature of the data; and
present the acquired work logs for each user involved in the creation of the data.

2. The information processing apparatus according to claim 1, wherein the processor is configured to:
specify a user who operates the data as the user involved in the creation of the data.

3. The information processing apparatus according to claim 2, wherein the processor is configured to:
extract the user involved in the creation of the data from the work logs related to communication for the data between the specified user and another user.

4. The information processing apparatus according to claim 1, wherein the processor is configured to:
present the acquired work logs in an aspect in which an application or a service used in each work is identified.

5. The information processing apparatus according to claim 4, wherein the processor is configured to:
present an image corresponding to the application or the service used in each work as a content of each work.

6. The information processing apparatus according to claim 1, wherein the processor is configured to:
set different display aspects between a common work between the users and the work not common between the users.

7. The information processing apparatus according to claim 6, wherein the processor is configured to:
present the common work between the users by connecting the common work with a line.

8. The information processing apparatus according to claim 6, wherein the processor is configured to:
present the common work between the users by surrounding the common work with a frame.

9. The information processing apparatus according to claim 1, wherein the processor is configured to:
present a content of the work as a task having at least a designated period.

10. The information processing apparatus according to claim 9, wherein the processor is configured to:
present a phase including one or more tasks by specifying an end of the work of which an interval with a subsequent work is greater than or equal to a predetermined threshold value, as a boundary of the phase.

11. The information processing apparatus according to claim 10, wherein the processor is configured to:
present the phase by specifying an end of a common work among a plurality of the users as the boundary of the phase.

12. The information processing apparatus according to claim 1,
wherein the feature is at least any of the user involved in the creation of the data, a file name of the data, a title of the data, or a sentence described in the data.

13. A non-transitory computer readable medium storing a computer program causing a computer to execute a process comprising:
acquiring work logs that are work logs in which an operation of data selected by a user and a work other than the operation of the data performed between a start of creation of the data and the creation of the data are recorded, and include a feature of the data; and
presenting the acquired work logs for each user involved in the creation of the data.

14. An information processing method by a computer, the information processing method comprising:
acquiring work logs that are work logs in which an operation of data selected by a user and a work other than the operation of the data performed between a start of creation of the data and the creation of the data are recorded, and include a feature of the data; and
presenting the acquired work logs for each user involved in the creation of the data.
